(19) United States
(12) Patent Application Publication
(10) Pub. No.: US 2006/0099108 A1
(43) Pub. Date: May 11, 2006

(54) Transport device for transporting test strips in an analysis system

(76) Inventors: Hans List, Hesseneck-Kailbach (DE); Jochen Schulat, Mannheim (DE); Paul Jansen, Mannheim (DE); Volkar Zimmer, Laumersheim (DE); Michael Schabbach, Weinheim (DE); Manfred Augstein, Mannheim (DE); Werner Ruhl, Limburgerhof (DE); Hans-Peter Haar, Wiesloch (DE); Joachim Hoenes, Zwingenberg (DE); Karl Miltner, Frankenthal (DE)

Correspondence Address: THE LAW OFFICE OF JILL L. WOODBURN, L.L.C.;JILL L. WOODBURN, 128 SHORE DR., OGDEN DUNES, IN, 46368, US

(21) Appl. No.: 10/539,425

(22) PCT Filed: Dec. 22, 2003
(86) PCT No.: PCT/EP03/14709

§ 371 Date: Jun. 20, 2005

(30) Foreign Application Priority Data
Dec. 23, 2002 (EP) 02028894.0
Mar. 13, 2003 (DE) 10310935.8

(51) Int. Cl. G01N 21/73

(52) U.S. Cl. 422/58; 422/82.05

(57) ABSTRACT

According to the invention the analytical system includes a transport unit which is driven by piezoactive elements. The transport unit enables a direct or indirect transport of the test elements thus enabling a complete or partial automation of analytical methods. Furthermore the invention encompasses a transport unit for transporting a test element which according to the invention is controlled by an optical detector which detects the test element in the system.

### REFERENCE TO RELATED APPLICATIONS

The present application claims priority to PCT Application No. PCT/EP2003/014709 filed Dec. 22, 2003, German Patent Application No. 10310935.8, filed Mar. 13, 2003; and European Patent Application 02028894.0 filed Dec. 23, 2002.

### TECHNICAL FIELD

The present invention is within the field of sample liquid analysis by test elements.

### BACKGROUND

Such test elements are often analyte-specific, disposable test elements which contain a reagent that can be used to determine an analyte. In such test elements the reagent of the test element interacts with an analyte to be determined and thus induces a measurable, analyte-specific change in the reagent. Optical systems which enable an analysis of the sample are often used to measure and evaluate the reagent field especially in the case of an analyte-dependent change in the colour of the test element. The photometric evaluation of analytical test elements is nowadays one of the most commonly used analytical methods for rapidly determining the concentration of analytes in samples. In general photometric evaluation is used in the field of analytics, environmental analytics and above all in medical diagnostics. Test elements that can be evaluated photometrically or by reflection photometry are of major importance especially in the field of blood glucose determination in capillary blood. Such devices are for example used to monitor the blood sugar level of diabetics such that their eating habits or insulin injections can be regulated on the basis of the blood glucose value of the drawn sample. Other examples of the use of optical systems are urine test strips and test elements for other parameters such as lactate, creatinine, protein, uric acid and leucocytes. Furthermore reagent-free test elements are also used in which an analyte to be determined can also be measured with the aid of optical systems or for example electrochemically.

In addition to the use of analytical instruments in hospitals by trained medical staff, such analytical systems have also been designed for the home monitoring field to enable patients to monitor an analyte to be determined as regularly as possible. Common home monitoring analytical systems are used especially for blood glucose determinations. In this case the instrument is operated by the patient himself. In order to analyse the blood, a test element on which an analytical field is located is for example brought into contact with the blood of the patient and subsequently inserted into the instrument by the user. An optical change which is dependent on the analyte concentration is for example induced in the analytical field of the test element. The optical change in the light reflected or transmitted from the test element is detected by a suitable optical measuring system to determine the blood sugar concentration. Such a system is described for example in the document U.S. Pat. No. 5,424,035, which is hereby incorporated herein by reference. Furthermore such instruments are commercially available from Roche Diagnostics GmbH, Mannheim Germany, under the names ACCUTREND®, ACCUCHEK®, GLUCOTREND®, and GLUCOMETER®. The structure of the test elements that are provided for use is shown for example in the document U.S. Pat. No. 6,036,919, which is hereby incorporated by reference.

A general trend in carrying out analytical tests is to reduce the amount of sample required for the analysis. The reason for this is that often only small amounts of sample are available. For example with blood sugar determinations by diabetics a drop of blood is collected from the finger pad. A reduction of the required quantity of blood can in this case help to make the blood collection less painful for the person to be examined. The reason for this is that the puncture depth for blood collection can be reduced when small sample volumes are required. The reduced sample quantity is associated with a miniaturization of the test element and in particular of the detection zone in which for example the sample reacts with a reagent. However, in this connection it has turned out, especially with small amounts of sample, that changes in the technical measuring conditions in analytical systems play a major role and cause considerable errors in the determination of the concentration of an analyte. The reasons for technical changes in the measuring conditions are for example a faulty positioning of the test element in the analytical system so that for example it is not possible to evaluate the complete evaluation field of a test element. Hence an exact positioning of the test element in the analytical system is a prerequisite for an accurate measurement. This has to be ensured in the home monitoring field in which elderly and/or untrained persons often operate the instrument. But, on the other hand, analytical systems with test elements are also used in commercial laboratories in which an automated handling of samples often has to be assured.

Consequently positioning elements are now being employed to accurately position test elements in analytical systems. In this case the test element has to be inserted and guided into the analytical system and removed again either manually or automatically. In order to simplify the handling for the user, more and more instruments are now provided with an automatic drive for the test element especially in the case of instruments that contain and have to handle a store of test elements. This results in the requirements for automatic drive units which, on the one hand, transport a test element to a site in the analytical system and hold it in a defined position and, on the other hand, should enable the handling of a plurality of test elements in a magazine. Moreover in addition to the direct transport of the test element, it is often necessary to additionally or solely advance the magazine by one step. These requirements apply to partially and completely automated systems and are adapted to the respective field of application.

The integration of automatic drives in the measuring instrument is provided in some fields of application which require a complex transport of test strips due to special measuring procedures. For example such measuring procedures are used to calculate errors in an analyte concentration and determine the so-called blank value of a test element among others. Such a procedure is described in the document US2005054082 A1, which is hereby incorporated by reference. For the blank determination the test element is firstly transported into a measuring position in which the blank value of the test element is measured. Subsequently the test element is ejected so that the user can apply a sample to the test element. The test element is again positioned at the measurement site and an analyte concentration of the sample is measured.

Analytical systems are described in the prior art which use several mechanisms for transporting test elements and transport the test element to a position provided for measurement or for other process steps. The positioning of the actual detection area relative to the measuring system or to other process factors is promoted by a high precision of the drive components and by low manufacturing tolerances of the test elements. In conventional methods such drives are very complicated and expensive and for example employ servomotors or low-tolerance gear units. Currently known analytical systems that are subject to large-scale manufacturing of the test element can also be required to meet high demands on accuracy to enable the mechanical system to reliably transport and position the test element relative to the measuring system. The mechanical system used is usually very complex.

The document U.S. Pat. No. 6,475,436 B1, which is hereby incorporated by reference discloses an instrument mechanism that is used in an analytical instrument to transport and advance a test strip magazine by one step. For this purpose a magazine chamber is rotated into a position such that a plunger can be inserted into the strip storage pack and push out a test strip from the storage pack until the test field of the strip is positioned above the optical measuring system. Subsequently the magazine is advanced by one step. An electrical motor is used to drive the test strip and the magazine. The optical system is accommodated in a flap of the instrument and is positioned there to an accuracy of less than 1/10 mm. This requires many components and joins with low tolerances. Furthermore high demands are made on the manufacturing tolerances of the test strips. In operation the drive system proves to be loud and the operating speed is mediocre. Moreover the drive systems are so large that it is difficult to achieve a compact design of the analytical system which is especially desirable in the home monitoring field.

In order to promote the operability of the systems, the drive units additionally require lubricants which can contaminate the interior of the instrument housing and can for example be deposited on the test elements as a result of fraying processes. However, especially with the commercial analytical systems high demands are often made on the storage of test elements which require a constant and especially dry environment. Consequently such contamination results in an impairment of the measuring results especially in the case of test elements that are sensitive to moisture and contamination.

Currently known transport units may often only allow movement along one direction of movement. However, when using test element magazines it is often desirable to return the test elements to the cassettes. The recassetting of used test elements can simplify the handling of the analytical system in a user-friendly manner. However, this requires that the test elements can be transported in different directions of movement. But, a transport in different directions of movement can require a complicated additional transport unit.

### SUMMARY

According to the present invention a system and a method for transporting test elements is provided. The system and method provide positioning of the test element relative to the measuring system and enable magazine handling. This provides that a drive system could be handled in a flexible manner without requiring considerable additional expenditure. The system can as small and compact so that it can also be used expediently in analytical systems that are designed to be space saving for home monitoring. Contamination of the analytical system by a transport unit should be avoided. The system can also be integrated into battery-operated analytical systems.

According to the present invention an analytical system is provided. The system comprises a detection unit for detecting at least one signal that has been changed by an analyte in a sample and an evaluation unit to determine at least one analyte in the sample based on the at least one signal and a transport unit with a contact area. The contact area is suitable for directly or indirectly contacting the analytical system with a test element on which the sample can be applied. The transport unit comprises at least one piezoelectric element which vibrates the contact area of the transport unit and the test element is transported along a defined transport path in the analytical system as soon as the contact area of the transport unit is directly or indirectly contacted with a test element and the contact area is vibrated by the at least one piezoelectric element.

According to the present invention a method for transporting a test element in an analytical system is provided. The method comprises contacting a test element directly or indirectly with a contact area of a transport unit in an analytical system, and prior thereto or subsequently, activating a piezoelectric element of the transport unit such that the contact area of the transport unit is vibrated, transporting the test element due to the vibrated contact area along a predetermined transport path in the analytical system and stopping the transport process of the test element such that the test element is positioned at a predetermined site in the analytical system.

According to the present invention an analytical system for determining an analyte in a sample is provided. The system comprises a detection unit for detecting at least one signal that has been changed by an analyte in a sample, an, evaluation unit to determine at least one analyte in the sample based on the at least one signal, and a transport unit with a contact area. The contact area is suitable for direct or indirect contact with a test element on which the sample can be applied. The transport unit comprises at least one piezoelectric element which vibrates the contact area of the transport unit. The test element is transported along a defined transport path in the analytical system as soon as the contact area of the transport unit is directly or indirectly contacted with a test element and the contact area is vibrated by the at least one piezoelectric element. The transport of the test element is formed to be stopped such that the test element is positioned at a predetermined site in the analytical system.

According to the present invention, a method for controlling a transport unit in an analytical system is provided. The method comprises contacting a test element directly or indirectly by means of a test element carrier with a transport unit of an analytical system, the transport unit being able to transport the test element along a transport path in the analytical system, transporting the test element along the transport path, irradiating the test element or the test element carrier in a first wavelength range with a light source which is located along the transport path, and detecting an optical change which is due to the test element or the test element carrier wherein the transport unit in the analytical system is controlled on the basis of the detected optical change.

According to the present invention a system for controlling a test element transport is provided. The system comprises a transport unit which is able to transport a test element along a transport path within an analytical system either directly or indirectly by means of a test element carrier, a light source which is located in the analytical system along the transport path such that a test element or test element carrier which is transported along the transport path is irradiated in a first wavelength range and a detector for detecting an optical change which is caused by the test element or the test element carrier. The transport unit is contacted with the detector and the transport unit is controlled as a function of the signal detected by the detector.

These and other features of the present invention will be more fully understood from the following detailed description of the invention taken together with the accompanying claims. It is noted that the scope of the claims is defined by the recitations therein and not by the specific discussion of the features set forth in the present description.

### BRIEF DESCRIPTION OF THE DRAWINGS

The invention is further elucidated in the following to illustrate the invention.

FIG. 1: Bar-shaped drive element with two piezoelectric elements.

FIG. 2: Tubular piezoelectric drive element.

FIG. 3: Piezoactive element with drive rods.

FIG. 4: Analytical system with a piezoelectric motor and test elements.

FIG. 5: Drum-shaped test strip magazine with piezomotor.

FIG. 6: Test strip tape.

FIG. 7: Decrease in reflectance during test strip transport at 452 nm.

FIG. 8: Decrease in reflectance during test strip transport due to detection of a black bar.

FIG. 9: Test strip with various illumination zones.

Skilled artisans appreciate that elements in the figures are illustrated for simplicity and clarity and have not necessarily been drawn to scale. For example, the dimensions of some of the elements in the figures may be exaggerated relative to other elements to help improve understanding of the embodiment(s) of the present invention.

In order that the invention may be more readily understood, reference is made to the following examples, which are intended to illustrate the invention, but not limit the scope thereof.

### DETAILIED DESCRIPTION

The invention concerns the use of piezoelectric drives for the direct or indirect movement of test elements within a diagnostic instrument in order for example to position a test element relative to a detection unit, to remove and return test elements in a magazine and as an advancing mechanism for a magazine to mention only a few applications. The integration of a piezoelectric motor enables a flexible and comfortable automatic handling of test elements in an analytical system while substantially reducing motor noises, contamination etc.

The invention comprises an analytical system for determining an analyte in a sample. The analytical system is used to analyse a test element which has a carrier and an evaluation area on which a sample is applied. The test element is positioned in the analytical system such that at least one signal is detected by a detection unit of the system whereby said signal is changed depending on the sample applied to the test element. An evaluation unit of the analytical system is used to determine an analyte in the sample based on the signal. The analytical system also comprises a transport unit with a contact area in order to directly or indirectly contact the analytical system with a test element.

In this context a direct contact is for example when the test element carrier rests directly on the contact area of the transport unit. If, in contrast, the contact of the test element is indirect, the contact area of the transport unit firstly contacts an instrument component that is to be transported which acts as a transport carriage for the test element. Such a transport carriage can for example be a support area for the test element in the analytical system. Furthermore the indirect contact of the test element can for example be achieved in the form of a magazine housing which is in turn directly in contact with the contact area or indirectly in contact with the contact area via a transport carriage.

Stepping of the magazine results in a transport of the test element. In order to transport the test element, the transport unit has at least one piezoelectric element which vibrates the contact area of the transport unit. If the contact area of the transport unit is vibrated by the at least one piezoelectric element, the test element is transported along a defined transport path in the analytical system as soon as the contact area of the transport unit makes direct or indirect contact with the test element. If the direct or indirect contact between the contact area and the test element is interrupted or the vibration of the contact area is stopped, the transport of the test element is halted and the test element is positioned in a fixed position in the analytical system.

According to the invention a piezoelectric drive is used in the system as a drive for the transport unit such that the contact area of the transport unit is vibrated in such a manner that the contact area executes a resonance vibration. As a result of the resonance vibration (which will be explained in more detail in the following) points on the surface of the contact area make elliptical movements. If another body such as a test element contacts these points (contact points), the test element is at least partly conveyed further along a defined transport path in the analytical system. In this manner the body to be transported can be directly conveyed or indirectly conveyed by means of an additional component of the transport unit.

Hence within the sense of the invention the transport unit can be understood as a piezoelectric motor where the object to be transported which makes direct contact with the contact area, is itself a part of the piezomotor. Consequently if, for example, the test element rests directly on the contact area, the test element is a component of the motor and the piezoelectric motor comprises a disposable element. This is for example also the case when the contact area of the transport unit is directly contacted with a magazine housing which is also provided as a disposable article in the analytical system. It is of course also conceivable that an additional component of the transport unit e.g. a transport carriage, as already described, is provided as a non-exchangeable unit for indirectly contacting the test element or a magazine, and the piezoelectric motor contains no disposable elements.

The use of a piezodrive in an analytical system enables the transport unit to be integrated into the analytical system in a small and compact manner. In this connection the transport unit according to the invention enables an integration of the piezoelectric motor in or in the vicinity of a magazine housing without impairing the quality of the stored test elements by for example lubricant deposits. A compact design of the analytical system in which the test elements and motor are arranged spatially next to one another can be achieved according to the invention since the transport unit does not need lubricants due to its piezomotor. Moreover, the constant and dry conditions for storing test elements are particularly suitable for operating a piezomotor. This is primarily due to the fact that defined frictional and static frictional forces act under constant environmental conditions. Another characteristic of the drive is that large forces and moments are already generated at low speeds.

Furthermore it enables rapid changes in movement in the analytical system in which one direction of movement is rapidly and precisely changed or the test element is brought to a standstill. In this connection the standstill of the element that is in contact with the contact area takes place essentially without play in which case a maximal force (moment) acts on the element when it is at a standstill due to static frictional forces. Reversal of the direction of movement allows a flexible handling and the transport unit can even be constructed with a few components.

The general principle of a piezoelectric drive is known and described e.g. in Ultrasonic Motors—Theory and Application by S. Ueha and Y. Tomikawa; Oxford Science Publication, which is hereby incorporated by reference. The principle is described for illustration purposes in the following on the basis of an example.

The operating principle of a piezomotor is illustrated using a linear drive as an example without being limited thereto. A linear drive consists for example of a beam. The beam is made of a material of high rigidity and low intrinsic dampening, a non-limiting example of which is a metal, and carries a piezoactive element at each of the two ends. If alternating voltage is applied to the first piezoactive element such that the beam is made to vibrate in resonance, a standing wave consisting of longitudinal oscillations is generated in the beam. As a result of the longitudinal oscillations of the beam, the beam is contracted laterally at the sites which are being stretched and it is extended laterally at the compressed sites. As a result a point on the surface of the beam which is also referred to as a contact point within the scope of the invention, makes a small lateral and longitudinal movement relative to the axis of the beam due to the oscillations and its trajectory follows an elliptical path.

In order to transport a test element the test element in the described example is pressed directly onto the contact area. In the case of a test strip for a blood sugar determination it is usually a flat object which is mainly composed of a carrier foil made of plastic. If the bar is now vibrated by the piezoelectric element, the carrier foil makes contact with the contact points on the surface of the contact area. The carrier foil and hence the test element firstly follow the movement of the contact points due to the frictional forces acting between the carrier foil and contact area. However, for a short period in which the direction of movement of the contact points along the trajectory is reversed, the test element loses contact with the contact area due to its mass inertia and retains its state of movement before it is again transported further due to the acting forces. Hence the test element performs a uniform movement despite the forces that act intermittently. If the vibration frequency and amplitude are adjusted according to the properties of the element to be transported, the test element is transported along the defined direction of movement. The test element is moved until the vibration of the beam is stopped or contact between the contact area and carrier foil is permanently interrupted. If the vibration of the beam is stopped, the dynamic contact between the test element and contact area becomes a static contact which holds the test element in the position it has assumed due to static frictional forces. Consequently the frictional forces acting during the transport process are a fraction of the static frictional force which acts between the test element and contact area when the transport unit is at a standstill.

In an embodiment of the invention, the contact area of the beam and the carrier foil of the test element are designed such that when the test element is in permanent contact with the contact area of the beam the acting static frictional moment is sufficiently large to ensure a secure positioning of the test element at a site in the analytical system. The static frictional moment is about 1.5 times the drive moment of the piezomotor in order to prevent a slipping of the test element as soon as the transport unit is in a resting state, for example during the measuring process.

If a voltage is also fed to the second piezoactive element the beam can only vibrate along the area that is enclosed by the piezoelectric elements thus changing the length of the standing wave and consequently the resonance frequency of the beam.

Depending on whether current is applied to the piezoceramic stack in common mode or push-pull mode, the contact points execute a clockwise or anti-clockwise trajectory which, depending on the direction of rotation of the trajectory, transports the test element along a positive or negative direction of movement. The analytical system comprises piezoelectric elements that can be electronically actuated independently of one another so that the direction of transport along a spatial axis can be reversed by actuating the piezoelectric elements in a common or push-pull mode.

Furthermore it is possible to achieve a linear movement of an element to be transported by means of a standing bending wave as elucidated in more detail in the following description. An intermittent drive force can then be generated by placing a short tappet on the beam. The direction of movement can be turned round by changing between different resonance frequencies.

A flexible change in the transport device is an advantage especially in analytical systems that have to perform complex movement processes due to an automated measuring process. As already described, an example of this is blank measurements in which the test strip is moved several times towards and away from the measuring system, recassetting, magazine transport etc.

Numerous applications of the system of the present invention are conceivable due to the ability to reverse the transport direction of the test element. In an embodiment the test element can be transported and positioned relative to the detection unit before and/or after sample application, and after a measurement the test element can be transported back to the starting position. Also, a test element can be transported back into a magazine by a transport unit after a sample analysis for restorage. Furthermore it is also conceivable that, after measurement of the test element, an additional transport unit transports it to a second measuring position so that several measurements are carried out on the test strip within an analytical system. In general there is no limitation to the number of additional transport units in an analytical system. In this context the transport units can be used to position the test element relative to a detection unit for another measurement and, as already described, for restorage, ejecting the test strip, the stepwise advance of a magazine housing or test strip tape etc.

If the transport unit according to the invention is for example used to transport individual test elements or several test elements, the piezoelectric element is connected in an embodiment with a detector which enables a control of the piezoelectric element. An individual test element is for example registered by a detector at one site in the analytical system where a change in reflectance or transmission is detected by irradiating the test element. The detected change in reflectance or transmission generates a signal for controlling the piezoelectric motor. In this connection, the power supply to the piezoelectric elements can be interrupted so that an optical change due to the test element can be detected in the analytical system. If, for example, the test element transport is stopped immediately after detection of the test element, this enables an exact positioning of a test element at a defined position in the analytical system.

In principle, the control of test element transport can be based on a change in reflectance or transmission detected by a detector independently of the design of the transport unit. In this case the test element can be directly or indirectly transported for example in a magazine housing by means of a piezoelectric motor, electric motors or other drives that are well-known in the prior art. In general such control of test element transport is not limited to any specific drive unit for the transport unit but must essentially only comprise contacting the transport unit with an optical detector to generate a signal for controlling the transport unit and thus the transport of the test element which is dependent on an optically detected change. Furthermore, control of the transport unit can for example be based on the detection of reflected, transmitted or luminescent radiation so that the invention is not limited to any specific optical detection. The invention is illustrated in the following using the detection of reflected or transmitted radiation as an example whereby the examples are not to be understood as being a limitation. In this connection a change in an optically detectable radiation is detected according to the invention which for example is referred to as a change in reflectance or transmission etc. The radiation detected in this manner is referred to as a detection value.

Hence the invention also concerns a method for controlling a transport unit in an analytical system. In an embodiment of the invention, a test element is directly positioned on a transport unit of an analytical system so that the test element can be directly transported by the transport unit. However, it is also conceivable that one or more test elements are positioned on a transport carriage, as already described, which is conveyed by the transport unit and thus the test elements are indirectly transported in the sense of the invention. For example such a transport carriage or test element carrier is a magazine housing which contains a plurality of test elements and the transport unit advances the magazine e.g. in a stepwise manner. Hence the transport unit moves the test element directly or indirectly along a transport path in the analytical system in which a light source is located. The test element or test element carrier is irradiated with light in a first wavelength range and an optical change due to the test element or the transport carriage or the test element carrier is detected. The transport unit is controlled on the basis of the detected light. Furthermore the invention concerns a system for controlling test strip transport which comprises a transport unit for the direct or indirect transport of a test element along a transport path. The system has a light source which is located along the transport path and which irradiates the test element or the transport carriage in a first wavelength range. A detector for detecting optical changes caused by the test element or the transport carriage is contacted with a transport unit so that the transport unit is controlled on the basis of light detected by the detector.

If the test element is transported indirectly by a transport carriage, a mark attached to the transport carriage is detected by reflection photometry. If, in contrast, the test element is transported directly by the transport unit, the test element can also be measured on the basis of transmission or luminescence radiation in addition to detection of radiation reflected from the test element. In this connection the optical change caused by the test element can for example be detected on the basis of radiation reflected or transmitted by the carrier foil of the test element. Such a signal is then detected as soon as the test element crosses the light beam of a detection unit along the transport path in order to control the transport unit. Furthermore embodiments are conceivable in which a recess/hole in the test element is used for positioning. For example during the period in which the test element is detected, test element transport is stopped after an optical change caused by the hole is detected. Especially in the case of transmission measurement, detection of a hole in the test element allows a simple construction of the detection unit which does not detect light until the hole of the test element is located between the light emitter and detector. If, on the other hand, the carrier foil or other areas that are impermeable to light are located between the light emitter and detector, the optical path of the optical system is blocked and no light can be detected by the detector. Similar embodiments can of course also be realized for other measuring procedures such as reflectance measurement. However, in an embodiment of the invention the change in the radiation that is reflected or transmitted by the test element is caused by a test field of the test element which is provided for analysing a sample. For this purpose the test field has a different reflection or transmission value than the carrier material of the test element and this value is detected in order to control the transport unit. During transport of the test element along a detection unit which is used to control the drive unit, the detector firstly registers a first reflection, luminescence or transmission value at the start of the transport process. The first value registered by the detector is firstly due to the carrier material, e.g. a carrier foil of the test element and changes during the forward movement as soon as the test field of the test element is registered by the detection unit. The optically detected changes generated in this manner are the basis for controlling the transport unit which for example is stopped immediately after the signal exceeds or falls below a specified threshold value.

The method for controlling the drive unit is in general not limited to the detection of a threshold value. Thus for example control can also be based on registering a curve time-course of the detected values and the values derived therefrom. It is also possible to detect only one value or only to register whether it is below or above a value. Hence the method according to the invention for controlling a drive unit is not limited to the detection of certain values but can be varied as required.

The detection unit for controlling the transport process for example comprises one or more additional light sources and a detector which are arranged along the transport path and form a detection unit. Usually an LED can be used for such a light source which emits light in a spectral range of <600 nm, and in an another embodiment <500 nm. Investigations with conventional test elements have shown that the difference in reflectance between a conventional test carrier of a test strip and a test field is largest within this wavelength range. Of course other spectral ranges may prove to be suitable depending on the test element that is used and hence the invention is not limited to any specific wavelength range. Hence, in the described example the analytical system has another detection unit to control the transport unit in addition to a first detection unit which measures an analyte on the test element.

The position of the detection units relative to one another within the analytical instrument is selected such that when the transport unit is halted, the test field of the test element is directly positioned in a desired manner relative to the measuring optics of the first detection unit to allow measurement and evaluation of the test field. Within the scope of the invention the position within the analytical system of the test element on which an analysis of the test field is to be carried out is referred to as the detection position which in the described example is located on the transport path of the test element in the analytical system. Hence within the meaning of the invention a positioning of a test element at the detection position enables an essentially error-free evaluation of the test element in an evaluation area of the test field that is completely covered by the first detection unit.

If the test field is directly detected in order to control the transport unit, an additional detection unit for controlling the transport unit in the analytical system can be omitted. The first detection unit that is already integrated into the analytical system to evaluate the test field is then used to control the transport unit. Thus an additional light source and detector are not required which simplifies the instrument design and reduces costs. Of course combinations of the described embodiments are also conceivable in which for example only one detector is provided in the system but different light sources are used for the initial detection of the test field or analysis of the test field. In principle the system according to the invention is not limited to any specific test element or detection unit for determining an analyte so that a wide variety of known analytical methods in the prior art can be used. For example electrochemical measurements etc. can also be used to evaluate a test field in which case an additional optical detection unit may be required to control the test element transport.

If only one detection unit is used in the analytical instrument in an embodiment, the detection unit of the analytical system firstly detects the position of the test field to stop the transport of the test element immediately after registering the test field. Subsequently an analyte-specific signal from the test field of the test element is measured with the same detection unit in another wavelength range. The described method promotes an exact positioning of the test field relative to the detection unit that is also used to evaluate the test field. Thus, the optical measuring system is accurately positioned.

If, in another embodiment, the test field is detected by the first detection unit in order to control the transport unit but using the same wavelength range that was also used to evaluate an analyte-specific signal, this may under certain circumstances unfavourably influence the measuring accuracy of the method. This is especially due to the fact that firstly a first reflectance change is generated by the test field to control the transport unit before sample is applied to the test field. After sample application, an analyte-specific second reflectance change is generated which is used to evaluate an analyte concentration. Hence the second change in reflectance that is available for evaluating the analyte signal is reduced by the magnitude of the first reflectance change. Such a reduction in the reflectance change may lead to inaccuracies in the analyte determination depending on the field of application and the analyte to be determined. Consequently detection of the test field to control the transport unit in a second wavelength range in which no analyte determination takes place can, as already described, improve the accuracy of the analysis.

Furthermore it is also possible to use luminescent substances in the test field to detect the position of the test element. The excited luminescence radiation which is for example excited in the same wavelength range in which the analyte is measured is then used to detect the test field. However, the luminescent radiation can also be detected in a wavelength range that is different from that of the analyte signal. Consequently, depending on the test element that is used, it is also possible to detect the test field without requiring different wavelength ranges to irradiate the test field while at the same time ensuring an adequate analytical accuracy.

In addition to the detection of the test field for controlling test element transport, it is also possible to provide a mark e.g. in the form of a coloured bar to detect and control test element transport. Hence it is possible to optically detect a test element or transport carriage in many different ways. The use of additional marks may be used, for example, when the test elements are indirectly transported for example when there is a magazine transport unit to advance the magazine in a stepwise manner. In this case marks attached to the magazine housing can be used to detect the position of the magazine and thus promote an exact positioning of the magazine housing relative to other instrument components (e.g. drive plunger for test element/lancets etc.) that interact with the magazine housing.

The use of an additional mark directly on the test element allows that the magnitude of a reflectance difference can be selected depending for example on the colour of the mark without needing to adapt the light source in the analytical instrument. On the other hand the position of the mark on the test element allows a free selection of a desired positioning of the mark relative to the test field and thus relative to instrument components in the analytical system. This enables a versatile integration of the method/system according to the invention into the design of conventional analytical instruments. If the mark is located on a test element on the far side of the test field relative to the direction of insertion, embodiments are conceivable in which firstly the test field is detected and as a result of the detected difference in reflection the test strip transport is firstly slowed down. Transport is then stopped as soon as the mark results in a second reflectance difference. Hence the use of an additional mark allows a versatile integration of the system according to the invention into conventional analytical instruments as well as numerous embodiments for controlling the transport unit. The control of the transport unit can in principle be based on simple or complex processes. In addition to the possibility of immediately stopping the transport after detection of a transmission or reflectance difference etc., it is possible to trigger a transport stop for example only after a defined time interval after detection of a predetermined value. Furthermore, it is also possible to permanently monitor the positioning of the test element during the measuring process by the analytical system. For example if a test element that has previously been exactly positioned gets out of place during the measuring procedure, for example due to an external jolt, this incorrect positioning can be detected by the system in an embodiment. If, for example, a deviation from a threshold value is detected, the position of the test element can be corrected until a predefined threshold value is again registered by the detector by means of an appropriate control and activation of the transport unit. This promotes, among others, that the test field is only evaluated when the test element is correctly positioned.

Hence the method according to the invention can encompass a wide variety of embodiments which also include complex transport and control processes. In this context it is equally possible to detect several threshold values which result in a transport process at various speeds down to a transport stop as well as an initiation of the transport process.

The described control mechanisms for test strip transport promote among others an exact positioning of a test element relative to the detection unit so that a test field can be reliably detected for the analysis of a sample. Hence an exact positioning of the test element within the analytical instrument can be promoted without making high demands on the manufacturing tolerances of an analytical instrument and a test element. Moreover use of an additional mark on the test element allows larger tolerances for the positioning of one or more detection units and of other instrument components within the analytical instrument as well as for the test element production itself. Especially in the case of test elements that are manufactured in large numbers as disposable articles, a large manufacturing tolerance allows a considerable simplification of the manufacturing process and thus an economic production. Differences in tolerance due to the manufacturing process can be directly compensated during the measurement process by the inventive control of the test strip transport. This enables considerable cost savings especially for single-use articles.

In addition to detecting the test element at one site in the analytical system, it is also conceivable that a holder in the analytical system stops the transport of the test element. Such a holding device can for example be a simple mechanical barrier in the form of a stop. Furthermore it is also possible for the transport process to be stopped after a predetermined time. In this case the piezoelectric transport unit facilitates an exact calculation of the transport path per unit of time so that after a defined operating time for the transport unit an exact positioning of the test element is also possible.

The transport unit can for example be activated by a contact element which activates the transport unit when the test element makes contact with the contact area of the transport unit. Of course any other activation mechanisms are conceivable such as a separate actuation of the transport unit by a control button. The invention also comprises a method for transporting a test element in an analytical system. In this method the carrier of a test element is contacted with a contact area of a transport unit in an analytical system. A piezoelectric element of the transport unit vibrates the contact area of the transport unit. If the carrier of the test element has made contact with the contact area, the test element is transported in the analytical system along a predetermined transport path. The transport process of the test element is stopped at a predetermined site at which the test element is to be positioned to allow a positioning of the test element.

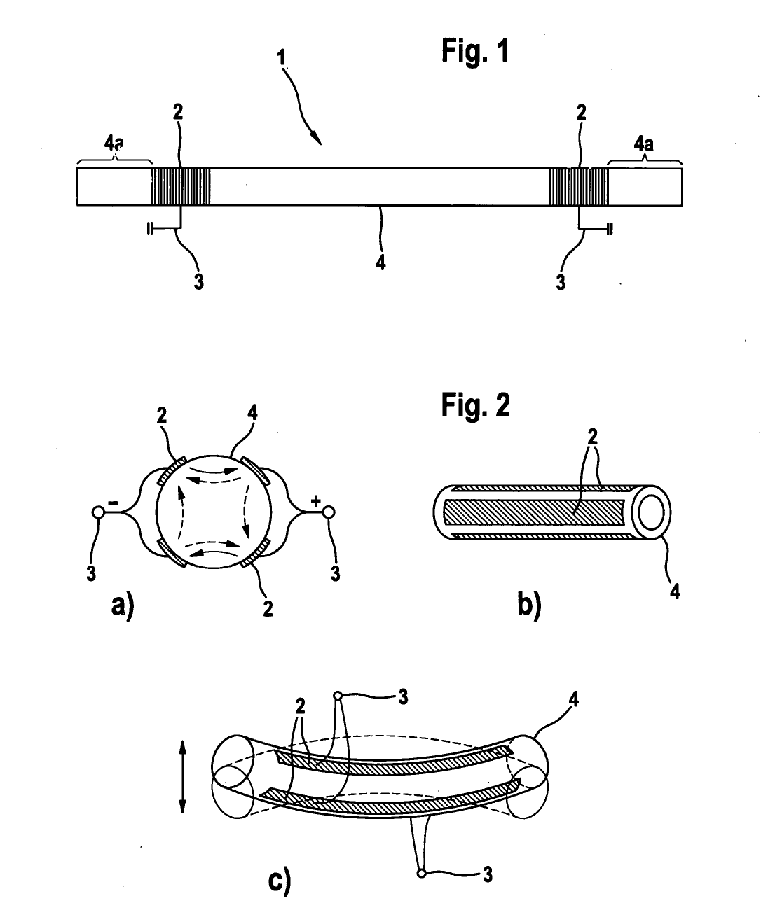

FIG. 1 shows the major components of a transport unit 1. The transport unit comprises a beam made of brass 4 to which a stack of piezoceramic plates 2 is attached to each end. Each of the piezoceramic plates has a separate electrical connection 3. Furthermore the ceramic plates are arranged at the respective ends of the beam 4 in such a manner that a standing wave comprising a longitudinal oscillation is generated in the beam when an alternating voltage is applied to one of the two piezo stacks, the length of the areas 4a of the beam that are distal to the piezo stack being chosen such that the piezo stack lies in the antinode of the standing wave that is to be generated. As a result of the lateral contraction of the beam associated with the longitudinal oscillation, a point on the surface of the beam executes an elliptical trajectory path. If current is now applied to the second piezo stack, the wave of the beam can no longer extend beyond the second piezo stack into the area 4a. As a result of applying current to the second piezo stack the beam now behaves as if it has been effectively clamped in the analytical system by the piezoceramic plates. If voltage is synchronously applied to both piezo stacks, points on the surface of the beam form a counterclockwise trajectory. If, on the other hand, current is applied to the second piezo stack in a push-pull manner, the standing wave that is generated is shifted by half a wavelength. A point on the surface which previously had a counterclockwise trajectory now has a clockwise trajectory which reverses the direction of transport of a test element conveyed by means of friction on the point. Consequently, it is possible to change the transport direction along the beam 4 by supplying power separately to the piezo elements and by a suitable selection of the current. This for example enables an analytical system to transport a test element from one support surface to the measuring system and to reverse the transport process after measurement such that the test element can be removed again by the user at a readily accessible site.

FIG. 2 (a-c) shows a cylindrical rod made of piezoceramic 4 which is covered with four electrodes 2. Each of the electrodes covers about ¼ of the circumference of the cylindrical rod and extends over the entire length of the rod. An electrical contact is made with the electrodes via the connectors 3. The electrical contacts shown in FIG. 2a result in a polarization of the ceramic which is shown by the dashed arrows. If an alternating voltage is applied to two opposing electrodes, the rod performs a bending oscillation (see FIG. 2c).

If an alternating voltage with a 90° phase difference is fed to the other two electrodes, the rod performs a revolving bending oscillation which results in an elliptical trajectory of a surface point on the surface of the rod in the area of the maximum amplitude.

An object that is pressed against this point on the rod will be carried along due to the frictional forces acting on it as already described. The direction of movement is reversed by changing the phase difference between the voltages from +90 to −90°.

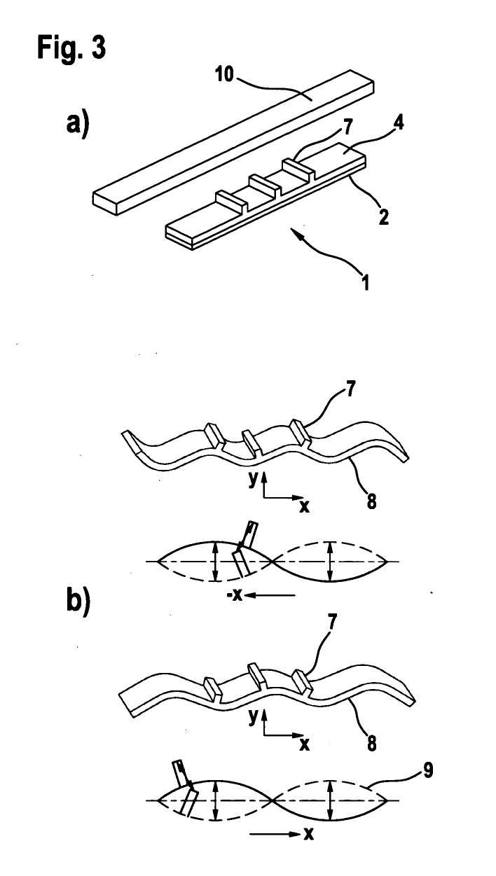

FIG. 3a shows a transport unit 1 with a drive plunger. The piezoactive element 2 is contacted with a beam 4. Drive rods 7 are positioned on the beam 4 which improve the transport property of the transport unit. If the beam 4 is vibrated by the piezoactive element, the beam performs a bending oscillation and a bending standing wave 8 is excited in the beam as shown in FIG. 3b. As already described the vibration 9 of the beam 4 results in an elliptical movement of contact points on the surface. If drive rods 7 are present on the contact points of the surface, the trajectory of the contact points that are now on the surface of the drive rod is enlarged depending on the length of the drive rod 7. The enlarged trajectory of the contact points improves the transport of an element 10 to be transported which rests on the drive rods. For example such a transport unit can generate forces in the range of 5 Newtons and a speed of 80 mm/s at a resonance frequency of 22.31 kHz. In this case the direction of movement is changed by applying a different resonance frequency.

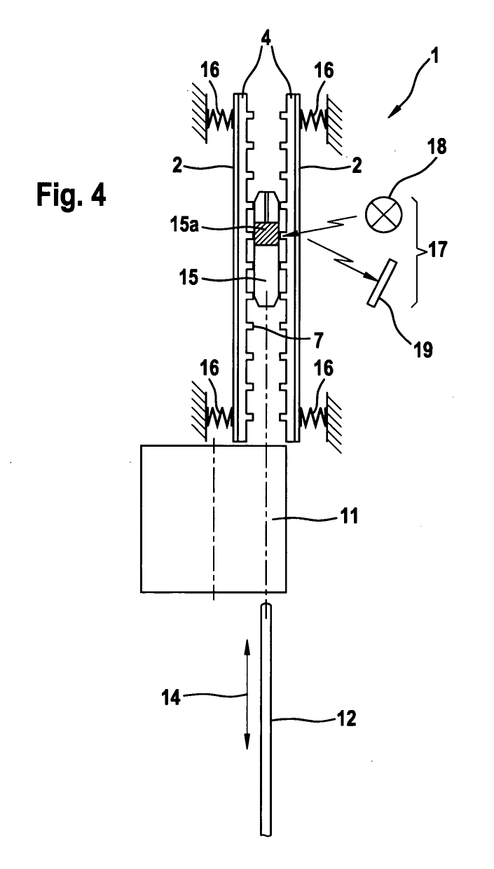

FIG. 4 shows an analytical system with a transport unit in which a test strip is directly driven by piezoelectric elements.

For this a test strip 15 is firstly pushed out of a magazine 11 along the direction of movement 14 by a plunger 12 until the test strip contacts the transport unit. The design of the transport unit is essentially similar to the transport unit in FIG. 3a and has two beams 4 that are equipped with drive rods 7. The beams 4 are connected to piezoactive elements 2 and are vibrated by them as soon as the transport unit is activated. The beams 4 and the piezoactive elements 2 are countertensioned and positioned by spring elements 16. When the test strip 15 comes into contact with the transport unit 1, the strip is picked up by the drive rods 7. The drive rods excited by the piezoelements on the outer sides of the beams 4 vibrate to such an extent that contact points on the surface of the drive rods perform elliptical movements which move the test element 15 along the transport path. In principle the transport of the strips can be stopped at any positions in the analytical system. In the example shown a test zone 15a of the test element 15 is detected at one site in the analytical system to control the transport unit and the transport unit is stopped as soon as the test zone 15a has been detected. A detection device 17 which is also used for the optical analysis of the test zone 15a is used to detect the test zone 15a. If the transport of the test strip is stopped immediately after detection of the test zone 15a, this promotes that the test zone 15a is correctly positioned relative to the detection device 17. Errors in the analysis of a sample in the test zone which are caused by an incorrect positioning of the strip can thus be avoided. The detection device 17 consists essentially of a light source 18 to irradiate the test zone and a sensor 19 which detects radiation reflected by the test zone. When the transport of the test element is stopped, the spring elements 16 promote an exact positioning of the strip at the target site in addition to the static frictional force acting between the contact area of the drive unit and the test strip. If the frequency applied to the piezoactive elements 2 is changed, it is possible to reverse the direction of transport of the test element which enables the strip to be transported backwards. This enables the test strip to be placed back into the magazine 11 for storage.

In addition to the transport of a strip-shaped test element it is also possible for the transport unit to move the strip cassettes that are used to store test strips. For example a cylindrical test strip cassette can be rotated by a drive such that successive test strips can be removed from the cassette and a stepping of a test strip magazine can be achieved. In this case it has proven to be advantageous when the magazine does not directly contact the contact area of the transport unit since the magazine housing is often contaminated by for example fats due to handling steps. Such contamination can alter the frictional moment between the contact area and the housing to such an extent that it impairs the ability of the piezomotor to function. It has therefore proven to advantageous to drive the magazine housing by an additional instrument component which functions as a transport carriage in the piezomotor.

If a test strip is directly transported instead of the magazine housing, it is often possible to omit an additional transport carriage since the test element can be removed dust-free and fat-free from a cassette as a result of manufacturing processes. If test elements are not automatically handled by the analytical system so that the user has to manually insert the test element into the instrument, the use of a transport carriage may prove to be of advantage in this case.

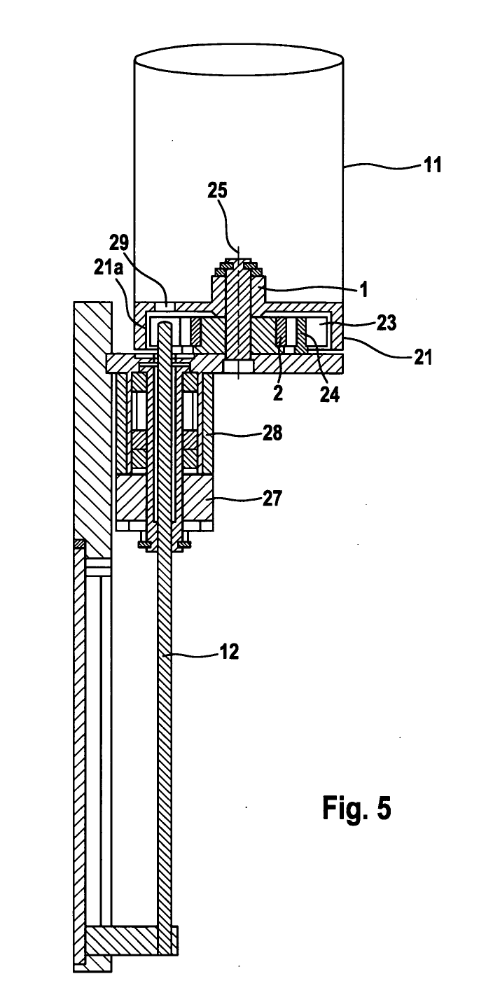

FIG. 5 shows a drive for a drum-shaped test strip magazine as known from the prior art and which is used by the Roche Company in the ACCUCHECK® Compact analytical system. The magazine 11 has a plurality of test elements (not shown) which are stored in individual chambers of the magazine. In order not to impair the quality of the test elements, the magazine is sealed with a foil at the ends of the drum. In addition the magazine has an additional drum 21 in its upper portion which closes the upper end of the magazine either alone or in addition to a foil. In order to achieve a compact design of the analytical instrument, the piezomotor is integrated into the drum 21 in order to advance the magazine. The drum and hence the magazine are mounted and positioned centrally on an axis 25 in the analytical system. A ring 2 made of piezoelectric material which is connected to lamellae 23 which form the contact area of the transport unit is positioned inside the drum. The lamellae 23 are pretensioned as a result of the intrinsic elasticity of the lamellae 23 which promote contact between the transport surface and the inner side 21a of the drum 21. The lamellae 23 are bent to such an extent that the lamellae point semitangentially in one rotation direction. If an alternating voltage is applied to the piezoelectric ring 2, the lamellae are vibrated. If the frequency corresponds to the resonance frequency of the lamellae, contact points on the surface of the lamellae that are in contact with the inside of the drum 21a form an elliptical trajectory. In accordance with the general principle that has already been described this results in a transport of the drum such that the magazine housing is rotated about its axis 25. Furthermore holding structures 24 are positioned in the drum interior so that the lamellae 23 and the piezoring 2 are themselves secured against rotation. A push rod 12 which has an external thread is present to eject the test elements from the drum. A rotor 27 which is driven by another piezomotor 28 is screwed onto the thread. The piezomotor 28 is tubular and is contacted with a mass electrode in the interior of the tube. Three working electrodes are attached (not shown) to the outer tube wall of the piezomotor 28. If a three-phase alternating voltage is applied to the electrodes, an expansion oscillation is induced which generates a revolving wave movement at the end faces (contact area) of the tubular motor which revolves the rotor 27. As a result the push rod 12 is screwed forwards so that it can penetrate into the magazine through the hole 29 in the bottom of the drum. When the phase of the alternating voltage is reversed, the direction of rotation is reversed and the push rod is retracted.

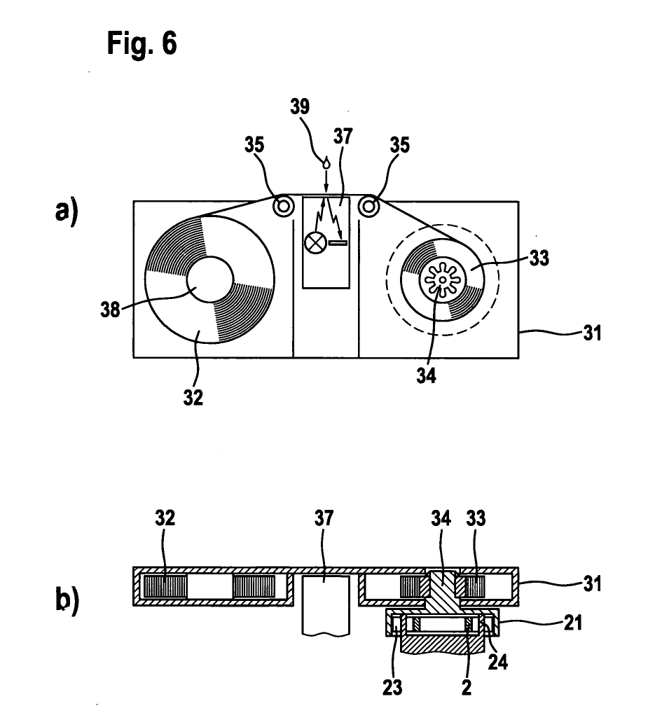

FIGS. 6a and b show an analytical instrument in which a plurality of test elements are arranged on a test strip tape. In this case the test elements are stored on a reel on which the test strip tape is wound. After a test element has been used, the used part of the tape is wound onto another reel according to the known principle in the prior art which is for example also used for audiotape cassettes. This enables test elements that have been already used to be returned to the magazine. Analytical instruments which use the described test elements are for example described in the documents WO US 02/18159 and EP 02 026 242.4, which are each hereby incorporated by reference.

The reels 32 and 33 of the test tape are mounted on a hub in the cassette housing 31. The hub for the waste reel 33 has a carrier structure into which the carrier element 34 engages at the side of the instrument. The underside of the carrier element 34 is in the form of a hollow drum 21 in which for example a piezomotor consisting of a piezoring 2 and lamellae 23 is clamped. The lamellae 23 are bent in one direction of rotation to promote that the motor is spring-clamped in the drum. If alternating voltage is applied to the piezoring 2, the lamellae 23 are vibrated similarly to the principle that has already been used in FIG. 5. This results in a rotation of the carrier element 35 resulting in a rotation of the waste reel 33 in a clockwise direction. Holding structures 24 are provided to prevent a rotation of the piezomotor itself. Of course the use of electromotors etc. is in principle also possible. However, the size and costs of the motor type have to be checked for the respective field of application. In addition care must be taken that the test element is not contaminated due to lubricants or other deposits from the respective motor.

In order to convey test elements in the analytical system, the piezomotor rotates the carrier element such that the waste reel 33 and consequently the tape reel 38 is rotated and the test strip tape 32 is wound onto the reel 33 by a defined amount. The test strip transport is such that a test field on a test strip tape is positioned above an optical system 37 located in the instrument. An exact positioning of the test element relative to the optical system is promoted by a static frictional force acting between the lamellae and carrier element as already described. In addition deflection rollers 35 and a passive brake of the tape reel 38 (not shown) promote a secure and stable guidance of the tape. The transport unit is controlled by the optical system in the instrument. The transport is stopped for example as soon as the test field can be registered by the optical system. Of course embodiments are conceivable with combinations of features that have already been described such that for example an additional optical system can be used or additional marks can be provided on the test strip tape. If a sample 39 is applied to the test field positioned in this manner, an analyte in the sample can be optically determined by means of the optical system 37. Subsequently the used test field is wound onto the waste reel by advancing the tape transport and is thus returned to the magazine. This allows a comfortable waste handling of used test elements.

Furthermore this enables a compact design of an analytical system since the piezomotor is in the direct vicinity of the test elements.

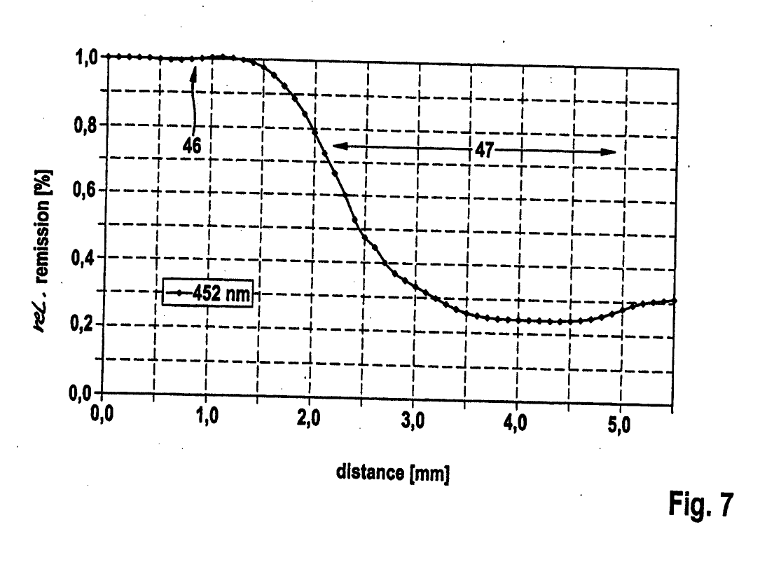

FIG. 7 shows an example of the curve time-course of measured reflectance values during test strip transport before sample application. The transport path [mm] is plotted versus the detected reflectance values (the reflectance was normalized against the reflectance value for the colour white so that a relative reflectance value is shown in the graphs). The test strip is for example transported by means of a piezoelectric motor. However, any other forms of drive units e.g. electromotors which are well known in the prior art are conceivable. An LED which emits light in a range of 452 nm is used as a light source to irradiate the test element. The LED is integrated into the analytical system in addition to the first detection unit for evaluating the test field and is only used to detect the position of the test field. For this purpose the LED emits radiation in a wavelength range that is not used to measure an analyte. However, the light reflected by the test field is detected by a detector of the detection unit so that an additional detector is not needed. If the test element is transported along the transport path to the detection unit in order to measure the test field, the test element carrier is firstly irradiated by the additional light source in the analytical system. In the example shown the test element comprises a white carrier foil which reflects light almost completely. This results in a reflectance value of 1 for radiation reflected by the carrier foil in a first region 46 of the curve. After the test element has been transported by 1.5 mm the detected reflectance value decreases in a second region 47 of the curve and reaches a minimum of ca. 0.25. In this position the test field of the test element is located above the detection unit in the analytical instrument where the measured reflectance value is generated by the detection of the test field itself. In an embodiment, test strip transport is stopped at this position resulting in a positioning of the test field above the detection unit. For example an immediate transport stop can be triggered when the reflectance value falls below a threshold of <0.6.

Furthermore, in addition to controlling the test element transport on the basis of threshold values, it is also possible to use complex control mechanisms which for example firstly result in a slowing down of the test strip transport at a first decrease in reflectance. Finally, transport is stopped when a further predefined reflectance value is detected. The initial deceleration of the transport enables a very precise control of the test element transport as already described and consequently enables the test field to be exactly positioned relative to the detection unit without making high demands on the manufacturing tolerances of the test element or of the analytical instrument.

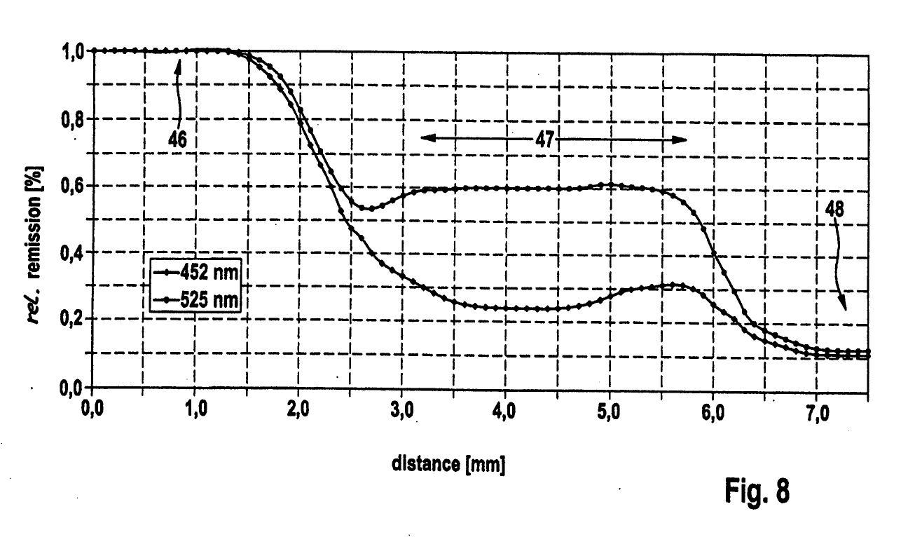

FIG. 8 shows a reflectance curve during a test strip transport according to the example shown in FIG. 7 at a wavelength of 452 nm and 525 nm. The curves at different wavelengths are qualitatively identical so that they start with a 100% reflectance when the white carrier foil of a test element is detected. The reflectance decreases when the test field is detected which has a plateau value of about 0.25 at a wavelength of 452 nm so that a maximum difference in reflectance of 0.75 between the carrier foil of the test element and the test field can be achieved. If the measurement is made at a wavelength of 525 nm, a plateau value of 0.6 is achieved when the test field is detected resulting in a reflectance difference of 0.4. This plateau value is already achieved with a transport path of about 2.5 mm. In the example shown the transport process is not stopped after detecting the test field so that the test element transport is firstly continued until a second reflectance difference is detected which is due to the black bar on the test strip and occurs in a third region 48 of the curve. The black mark decreases the reflectance to a value of 0.1 which can initiate a transport stop as soon as the reflectance falls below a threshold value of 0.15. This results in a corresponding change in reflectance compared to the detection of the test field of ca. 0.5 for a measurement at 525 nm. The described curves illustrate the different ways in which the inventive method can be adapted depending on the test element and the analytical instrument. If the test strip is measured at 525 nm, there is a considerable difference in the reflectance between the test field and mark when a black mark is used on the test element and hence the use of a black bar is recommended in the said wavelength range. If, in contrast, the measurement is carried out at 452 nm an additional mark is unnecessary since there is already a sufficiently pronounced difference in reflectance between the carrier foil and test field in this wavelength range. However, this also shows that measurement of an analyte-specific signal at 452 nm presumably would not give a satisfactory result. An analyte-specific absorbance of the light can only result in a reflectance difference of no more than 0.2. However, the evaluation of an analyte concentration based on such a small difference in reflectance often proves to be erroneous and should therefore be avoided. If, on the other hand, the test field is irradiated at a wavelength of 525 nm, a reflectance difference of 0.6 remains which can be regarded as adequate to evaluate an analyte-specific signal. If, however, a difference in reflectance between the carrier foil of the test element and the test field is not regarded to be of sufficient magnitude at a wavelength of 525 nm to detect the position of the test element, an additional black mark can be used as described in the example. In this manner the use of a single light source enables detection of the test element in order to detect its position in the analytical instrument and also allows the analysis of a sample with sufficient accuracy. Hence an additional light source in the analytical instrument is not needed.

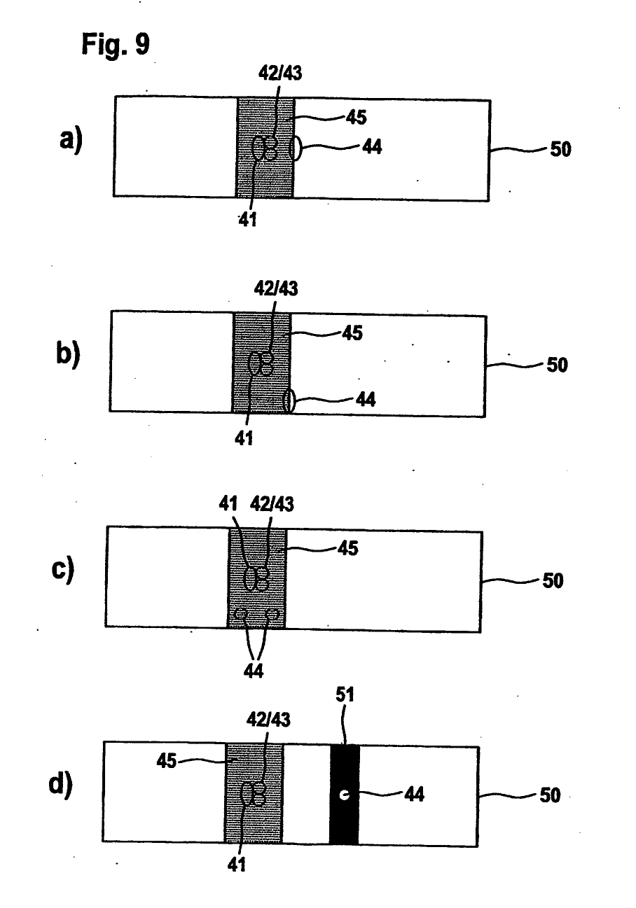

FIGS. 9a-9d show examples of various embodiments of the method/system according to the invention in which illumination zones are arranged differently on a test strip. The resulting arrangements of light emitters are selected as examples and show only a few possible embodiments. Of course in principle any arrangements are possible which generate an optically detectable change during test strip transport thus enabling control of the transport unit.

The test strip shown in FIG. 9a has a white carrier foil and a test field 45 which has a different colour. The zones 41, 42 and 43 that are shown represent the areas of the test element that are irradiated by three different light sources in the analytical system and are measured correspondingly. Within the scope of the invention these areas are referred to as illumination zones. The areas of the test element labelled 42 and 43 are used to measure the analyte present in the test field and are positioned in the middle of the test field which defines the evaluation area of the test field. A measurement to detect underdosing is additionally carried out in the area labelled 41 in a manner which is well-known in the prior art and is for example described in US2004136871 A1, which is hereby incorporated by reference.

In principle the system can be extended according to needs in order to measure blank values, white values or black values as described in US2005054082 A1 which is hereby incorporated by reference. Hence area 41 is arranged on the test field 45 in a known manner, as used in conventional systems, and is an example of possible embodiments that are usually used to evaluate a test element. The control of test strip transport according to the invention is, however, independent of such embodiments and hence only the illumination zones 44 which are used according to the invention to control the transport unit, are varied in order to illustrate the invention in FIGS. 9a-d.

The illumination zones 44 shown in FIG. 9a cover areas of the test field as well as the carrier foil of the test strip. Hence measurement of the labelled area results in a change in reflectance that is based on radiation reflected from the carrier foil as well as from the test field. A threshold value to control the transport process is adapted according to the reflectance differences obtained in this manner. When the values fall below a threshold value defined in this manner this immediately initiates a halting of test strip transport. After the transport of the test strip has stopped, the test element is in an appropriate position to allow the evaluation area 41 of the test strip to be completely detected by the detection unit.

In FIG. 9b the illumination zone 44 is arranged like that of FIG. 9a so that areas of the carrier foil as well as of the test field are detected. However, in this case the illumination zone is positioned at an outer edge of the test element. This prevents interference by a blood sample applied to the test field which would result in a non-reproducible change in reflectance. This utilizes the fact that in the example shown the blood is applied in a front region 50 of the test element and the sample is conveyed exclusively into the middle of the test field by means of a capillary gap. Hence the edge region of the test field in which the illumination zone 44 is positioned does not come into contact with the sample. Consequently this promotes a reproducible detection of a predetermined change in reflectance in a simple manner without the risk of interfering effects by the sample application.

In FIG. 9c the corresponding illumination zones 44 are arranged within the test field in an edge region that is not contaminated when the sample is applied. In comparison to FIG. 9b the test field has two illumination zones 44 that are irradiated by two LEDs in the analytical system. Since both illumination zones are within the test field, a reflectance value of the light reflected from the test field is detected as a function of the wavelength that is used corresponding to the values shown in FIGS. 7 and 8. The respective threshold values are chosen accordingly to control test strip transport whereby one utilizes the arrangement of the two illumination zones. When the test strip is transported a first change in reflectance is detected when the first area 44 of the test field is irradiated. This firstly results in a slowing down of test element transport. If a second change in reflectance is detected due to irradiation a second illumination zone in the test field, the test element transport is stopped. The positions of the two illumination zones 44 within the test field are selected such that the evaluation area of the test field is between the two illumination zones thus reliably ensuring a complete detection of the evaluation area 42, 43.

FIG. 9d shows a test element with an additional mark 51 to control test strip transport which extends over the whole width of the test element in the form of a black bar. According to FIG. 8 test strip transport is stopped as soon as a change in reflectance caused by the detection of the mark is registered. Due to the spatial separation of the test field and the mark, two detection units are integrated into an analytical system to measure the strip shown in FIG. 9d. The mark on the test element and the detection units are oriented relative to one another in such a manner that the evaluation area of the test field is positioned above the optical measuring system of the first detection unit as soon as the radiation reflected by the mark is detected by the second detection unit. An immediate stop of the test element transport then leads to an exact positioning of the test field relative to the first detection unit.

In principle a variety of possibilities are conceivable for arranging an illumination zone 44 on a test strip to control test strip transport. The examples illustrate only a few embodiments which are examples of the many different possibilities whereby the illumination zones, the evaluation area of the test field and the light emitter or light emitters and detectors can be appropriately matched to one another.

Having described the invention in detail and by reference to specific embodiments thereof, it will be apparent that modification and variations are possible without departing from the scope of the invention defined in the claims. More specifically, although some aspects of the present invention are identified herein, it is contemplated that the present invention is not necessarily limed to these one aspects of the invention.

What is claimed is:

1. Analytical system for determining an analyte in a sample, the system comprising
a detection unit for detecting at least one signal that has been changed by an analyte in a sample and
an evaluation unit to determine at least one analyte in the sample based on the at least one signal and
a transport unit with a contact area wherein the contact area is suitable for directly or indirectly contacting the analytical system with a test element on which the sample can be applied and the transport unit comprises at least one piezoelectric element which vibrates the contact area of the transport unit and the test element is transported along a defined transport path in the analytical system as soon as the contact area of the transport unit is directly or indirectly contacted with a test element and the contact area is vibrated by the at least one piezoelectric element.

2. Analytical system as claimed in claim 1, which is used to analyse the test element wherein the test element comprises a carrier and an evaluation area on which the sample is applied.

3. Analytical system as claimed in claim 1, in which the test element is present in a magazine housing.

4. Analytical system as claimed in claim 1, in which a detection site is located in the analytical system along the transport path.

5. Analytical system as claimed in claim 1, comprising at least two piezoelectric elements that are electronically actuated independently of one another.

6. Analytical system as claimed in claim 1, in which the piezoelectric element is contacted with a detector and the detector is used to control the at least one piezoelectric element.

7. Analytical system as claimed in claim 6, in which the detector is a component of the detection unit.

8. Analytical system as claimed in claim 6, in which the detector detects the evaluation area of a test element.

9. Analytical system as claimed in claim 2, in which the contact area of the transport unit and the carrier of the test element are made such that in a resting state of the transport unit static frictional forces act between the contact area and the carrier to such an extent that the test element is fixed in position relative to the transport unit.

10. Analytical system as claimed in claim 1, in which the transport unit has a contact sensor which activates the transport unit when the test element contacts the contact area of the transport unit.

11. Analytical system as claimed in claim 1, in which the transport unit causes a carrier element to rotate which is suitable for bearing and positioning a reel.

12. Analytical system as claimed in claim 11, which is suitable for using a test strip tape wound onto the reel.

13. Method for transporting a test element in an analytical system comprising
contacting a test element directly or indirectly with a contact area of a transport unit in an analytical system, and prior thereto or subsequently activating a piezoelectric element of the transport unit such that the contact area of the transport unit is vibrated,
transporting the test element due to the vibrated contact area along a predetermined transport path in the analytical system and
stopping the transport process of the test element such that the test element is positioned at a predetermined site in the analytical system.

14. Method as claimed in claim 13, in which the test element is positioned relative to a detection site of a detection unit of the analytical system.

15. Method as claimed in claim 13, in which the test element is returned into a magazine.

16. Method as claimed in claim 13, wherein the analytical system comprises a detection unit for detecting at least one signal that has been changed by an analyte in a sample and an evaluation unit to determine at least one analyte in the sample based on the at least one signal and the transport unit with the contact area wherein the contact area is suitable for directly or indirectly contacting the analytical system with a test element on which the sample can be applied and the transport unit comprises at least one piezoelectric element which vibrates the contact area of the transport unit and the test element is transported along a defined transport path in the analytical system as soon as the contact area of the transport unit is directly or indirectly contacted with a test element and the contact area is vibrated by the at least one piezoelectric element.

17. Analytical system for determining an analyte in a sample, the system comprising
a detection unit for detecting at least one signal that has been changed by an analyte in a sample,
an evaluation unit to determine at least one analyte in the sample based on the at least one signal, and
a transport unit with a contact area wherein the contact area is suitable for direct or indirect contact with a test element on which the sample can be applied and the transport unit comprises at least one piezoelectric element which vibrates the contact area of the transport unit and the test element is transported along a defined transport path in the analytical system as soon as the contact area of the transport unit is directly or indirectly contacted with a test element and the contact area is vibrated by the at least one piezoelectric element, wherein the transport of the test element is formed to be stopped such that the test element is positioned at a predetermined site in the analytical system.

18. Method for controlling a transport unit in an analytical system comprising
contacting a test element directly or indirectly by means of a test element carrier with a transport unit of an analytical system, the transport unit being able to transport the test element along a transport path in the analytical system,
transporting the test element along the transport path,
irradiating the test element or the test element carrier in a first wavelength range with a light source which is located along the transport path, and
detecting an optical change which is due to the test element or the test element carrier wherein the transport unit in the analytical system is controlled on the basis of the detected optical change.

19. Method as claimed in claim 18, in which the transport unit is controlled by a comparison of the registered detection value with at least one predefined detection value.

20. Method as claimed in claim 19, in which the test element transport is stopped as soon as a registered detection value falls above or below a predefined value.

21. Method as claimed in claim 19, in which at least two detection values are predefined which are compared with the registered detection values.

22. Method as claimed in claim 18, in which the test element transport is firstly slowed down before a transport stop occurs.

23. Method as claimed in claim 18, in which the light source emits light of less than 600 nm.

24. Method as claimed in claim 18, in which the transport of the test elements is initiated or stopped on the basis of the registered detection value.

25. System for controlling a test element transport comprising
a transport unit which is able to transport a test element along a transport path within an analytical system either directly or indirectly by means of a test element carrier,
a light source which is located in the analytical system along the transport path such that a test element or test element carrier which is transported along the transport path is irradiated in a first wavelength range and
a detector for detecting an optical change which is caused by the test element or the test element carrier wherein the transport unit is contacted with the detector and the transport unit is controlled as a function of the signal detected by the detector.

26. System as claimed in claim 25, in which the transport unit is contacted with the detector via a control unit.

27. System as claimed in claim 26, in which the control unit comprises a storage unit in which at least one predefined detection value is stored and the transport unit is controlled by comparing the detected detection value with the preset detection value.

28. System as claimed in claim 25, which is suitable for evaluating a test field of a test element.

29. System as claimed in claim 28, in which a test field is optically evaluated using the detector and/or the light source that are provided for controlling the transport unit.

30. System as claimed in claim 25, comprising a test element which has a test field for an analyte determination and the test field is detected in order to control the transport unit.

31. System as claimed in claim 25, comprising a test element with a mark which is detected to control the transport unit.

32. System as claimed in claim 31, in which the mark has a reflectance value normalized against white of less than 0.2.

33. System as claimed in claim 31, in which the mark is formed by a recess in the test element.
